(19) United States
(12) Patent Application Publication
(10) Pub. No.: US 2024/0151906 A1
(43) Pub. Date: May 9, 2024

(54) FUSION SPLICED OPTICAL CONNECTOR

(71) Applicant: Panduit Corp., Tinley Park, IL (US)

(72) Inventor: Satish I. Patel, Roselle, IL (US)

(73) Assignee: Panduit Corp., Tinley Park, IL (US)

(21) Appl. No.: 17/983,813

(22) Filed: Nov. 9, 2022

(51) Int. Cl. G02B 6/255

(52) U.S. Cl. CPC G02B 6/2558

(57) ABSTRACT

An optical connector houses and holds a fusion spliced portion with a short optical fiber fitted to an optical connector ferrule is fusion-spliced with a buffered optical fiber. One end of a protection sleeve which reinforces said fusion spliced portion is configured to be adhered to a buffer on the short optical fiber fitted to the optical connector ferrule and another end is adhered to a buffer of the buffered optical fiber. The protection sleeve has an inner heat shrink tube, an outer heat shrink tube, and at least one element that allows the protection sleeve to be concentric to the ferrule and cable buffer axis.

### FIELD OF THE INVENTION

The present invention relates generally to fusion spliced fiber connectors, and more specifically, to a method and apparatus of protecting the fusion spliced fiber in the connector.

### BACKGROUND

To make a connection with field fiber using a splice-on connector approach, Panduit currently offers mechanical splice-on connectors under the Opticam name in LC, SC and ST styles as detailed in U.S. Pat. Nos. 7,011,454 and 8,256,970. The Opticam connectors feature factory polished ferrule with stub fiber disposed in index matching gel inside the connector. For termination, field fiber is stripped, cleaned, and cleaved to a set length and inserted into the connector to align with the stub fiber through index matching gel. Once field fiber is aligned, cam action buffer clamp secures the field fiber into place to prevent any movement. The Opticam mechanical splice-on connectors are easy to terminate and do not require expensive termination tools. It uses index matching gel to transfer signal from field fiber to stub fiber. As optical property of the glass and gel is not identical, mechanical splice-on connectors have higher insertion loss.

What is needed is a fusion splice type splice-on connector where glass is fused thermally to offer lowest loss connector. This type of connector was not preferred in the industry due to the extremely high cost of the fusion splice equipment, but lately cost of fusion splice equipment has come down to make this type of connector cost effective for field use.

### SUMMARY

An optical connector houses and holds a fusion spliced portion with a short optical fiber fitted to an optical connector ferrule is fusion-spliced with a buffered optical fiber. One end of a protection sleeve which reinforces said fusion spliced portion is configured to be adhered to a buffer on the short optical fiber fitted to the optical connector ferrule and another end is adhered to a buffer of the buffered optical fiber. The protection sleeve has an inner heat shrink tube, an outer heat shrink tube, and at least one element that allows the protection sleeve to be concentric to the ferrule and cable buffer axis.

### BRIEF DESCRIPTION OF THE DRAWINGS

FIG. 1 shows a trimetric view of fusion splice connector assembly 10.

FIG. 2 is an exploded view of fusion splice connector 20.

FIG. 3 is an exploded trimetric view of ferrule assembly 60.

FIG. 4 is a trimetric view of ferrule assembly 60 showing top keying groove 140 and side keying groove 150.

FIG. 5 is a trimetric view of housing 40 showing top keying feature 160 and side keying feature 170.

FIG. 6 is a trimetric view showing protective sleeve 70.

FIG. 7 is a trimetric view showing rear assembly 230.

FIG. 8 is a trimetric view showing components in as-shipped configuration.

FIG. 9 is a trimetric view showing assembly steps 1 and 2.

FIG. 10 shows assembly step 3.

FIG. 11 shows assembly step 4.

FIG. 12 shows assembly step 5.

FIG. 13 shows assembled connector 10.

### DESCRIPTION OF THE INVENTION

The present invention is a splice-on fusion splice connector with a splice protection sleeve having dual reinforcing rods and heat shrinkable tubes. The splice protection sleeve adheres to factory fiber buffer on ferrule end and field fiber buffer on the other end. Duel reinforcing rods reinforce the fusion spliced section between the two buffers. Dual rods allow splice protection sleeve to be concentric to the buffer diameter and provide even support on both sides of the buffer central axis. The splice protection sleeve shown in this invention features dual reinforcing rods, but it can have one or more reinforcing rods made of metal or plastics. The invention shown here is for an LC style connector, but this invention can be implemented in SC or ST style fiber optic connectors.

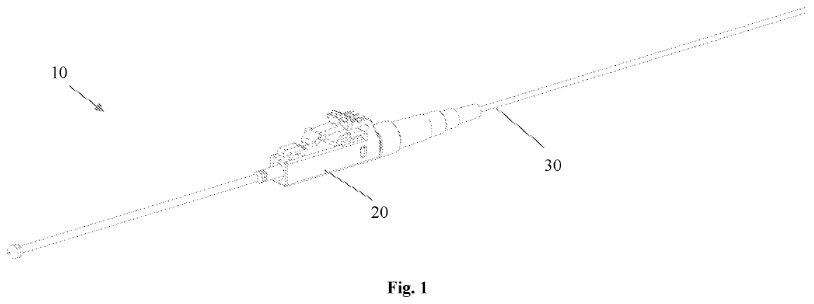

FIG. 1 shows a trimetric view of fusion splice connector assembly 10. Fusion splice connector 20 is terminated to fiber optic cable 30.

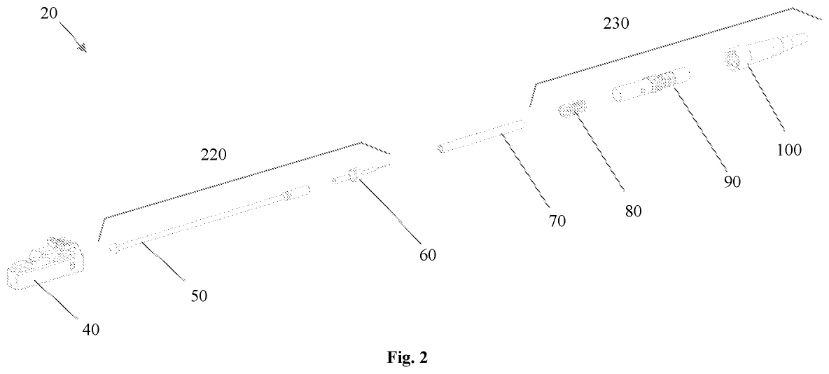

FIG. 2 is an exploded view of fusion splice connector 20. Fusion splice connector 20 includes dust cap 50, housing 40, ferrule assembly 60, protective sleeve 70, spring 80, backbone 90 and boot 100. Dust cap 50 features tether to ease handling during assembly. Tether can be broken off after assembly if desired. Dust cap 50 is supplied assembled to ferrule assembly 60 to protect ferrule interface. It is identified as front assembly 220 in this view. The spring 80, backbone 90 and boot 100 are shipped assembled to customer as rear assembly 230 to reduce the number of separate pieces to be assembled in the field.

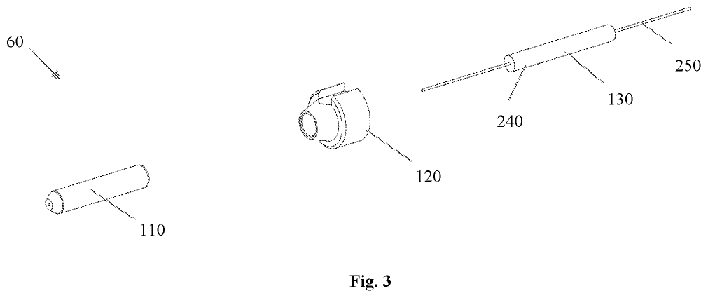

FIG. 3 is an exploded trimetric view of ferrule assembly 60. It includes ferrule 110, ferrule holder 120 and fiber 130. Fiber 130 includes buffer 240 and glass fiber 250.

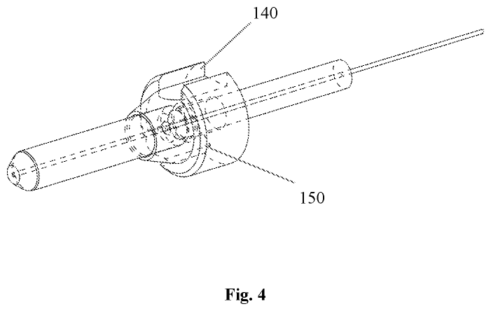

FIG. 4 is a trimetric view of ferrule assembly 60 showing top keying groove 140 and side keying groove 150.

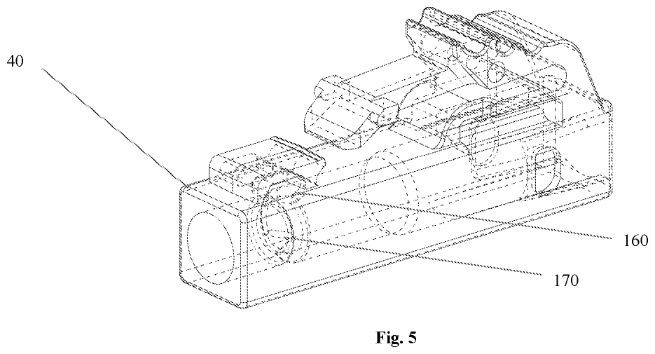

FIG. 5 is a trimetric view of housing 40 showing top keying feature 160 and side keying feature 170. Top keying feature 160 and side keying feature 170 must be aligned with top keying groove 140 and side keying groove 150 respectively to be able to assemble ferrule assembly 60 to housing 40. The keying features help assure ferrule assembly orientation.

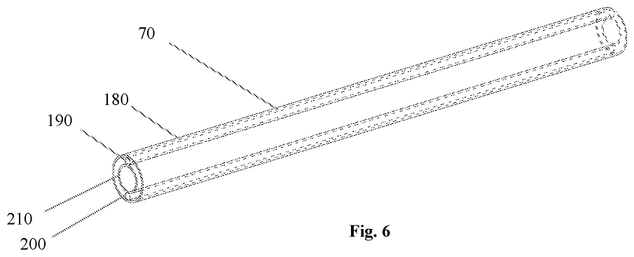

FIG. 6 is a trimetric view showing protective sleeve 70. It includes outer heat shrink tube 180, reinforcing rods 190 and 200 and inner heat shrink tube 210.

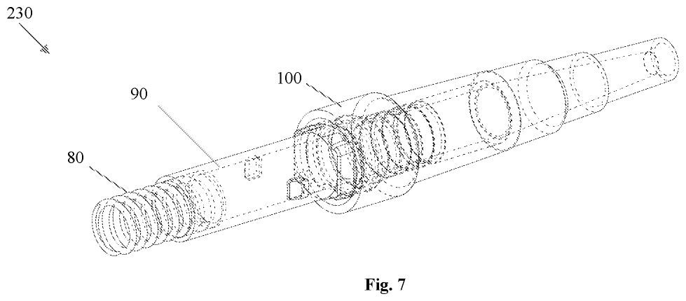

FIG. 7 is a trimetric view showing rear assembly 230. Spring 80 is partially pressed into backbone 90 and boot 100 is snapped on to backbone 90.

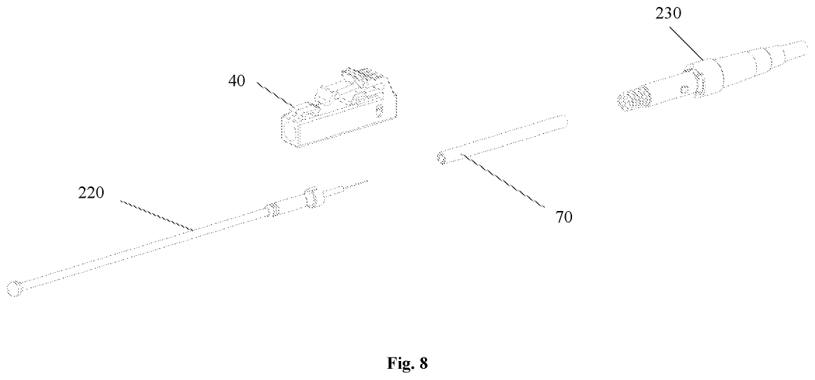

FIG. 8 is a trimetric view showing components in as-shipped configuration.

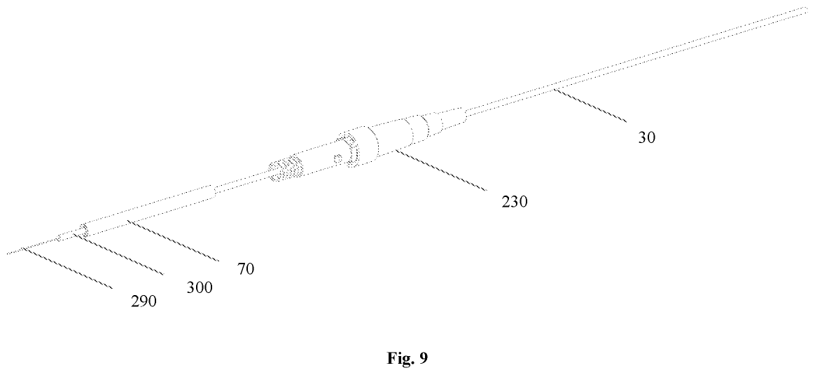

FIG. 9 is a trimetric view showing assembly steps 1 and 2. In step 1 rear assembly 230 and protective sleeve 70 are threaded on to fiber optic cable 30. In step 2 cable buffer 300 is stripped and glass fiber 290 is cleaved.

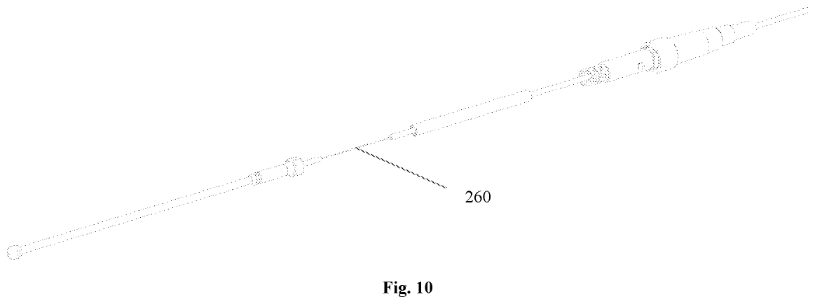

FIG. 10 shows assembly step 3. In this step front assembly 220 is fusion spliced to cleaved glass fiber 290 at fusion splice point 260 using fusion splice equipment.

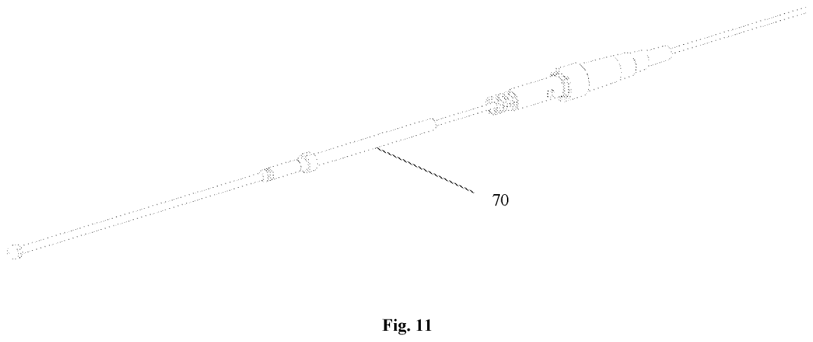

FIG. 11 shows assembly step 4. In this step protective sleeve 70 is slipped over the buffer 240 behind the ferrule holder 120 and cable buffer 300. Protective sleeve 70 is heat shrunk using fusion splice equipment.

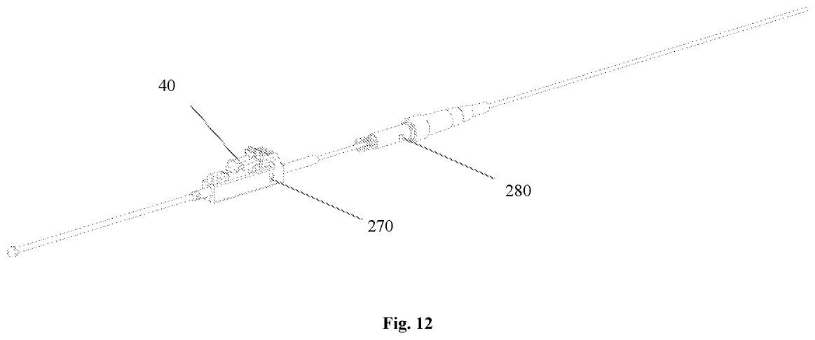

FIG. 12 shows assembly step 5. In this step dust cap 50 tether is pulled thru housing 40 while aligning top keying groove 140 with top keying feature 160 and side keying groove 150 with side keying feature 170. In step 6, rear assembly is assembled to housing 40. Backbone latches 280 latch to housing latch windows 270.

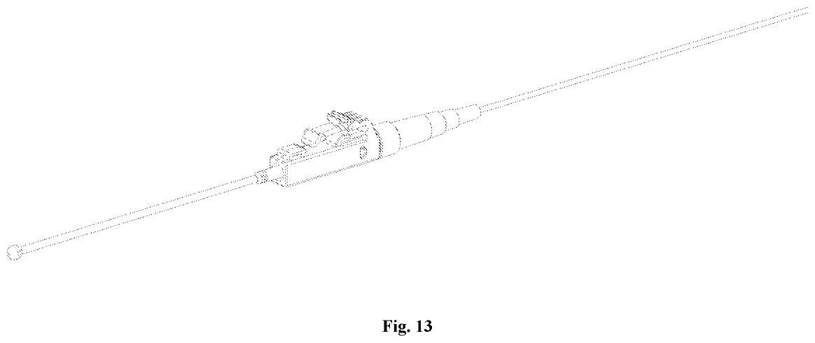

FIG. 13 shows assembled connector 10.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An optical connector which houses and holds a fusion spliced portion where a short optical fiber fitted to an optical connector ferrule is fusion-spliced with a buffered optical fiber, wherein: one end of a protection sleeve which reinforces said fusion spliced portion is configured to be adhered to a buffer on the short optical fiber fitted to the optical connector ferrule and another end is adhered to a buffer of the buffered optical fiber, and the protection sleeve comprises: an inner heat shrink tube, an outer heat shrink tube, and at least one element that allows the protection sleeve to be concentric to the ferrule and cable buffer axis wherein the element that allows the protection sleeve to be concentric to the ferrule and cable buffer axis comprises at least two reinforcing members retained between the inner and outer heat shrink tube.

2. The optical connector of claim 1 wherein the element that allows the protection sleeve to be concentric to the ferrule and cable buffer axis comprises at least two reinforcing members.

3. The optical connector of claim 1 wherein the at least two reinforcing members consists of two reinforcing rods.
